(19) United States
(12) Patent Application Publication
(10) Pub. No.: US 2006/0239127 A1
(43) Pub. Date: Oct. 26, 2006

(54) Multifunctional desk-top inductive clock

(76) Inventor: Tey-Jen Wu, Taipei City (TW)

Correspondence Address: BACON & THOMAS, PLLC, 625 SLATERS LANE, FOURTH FLOOR, ALEXANDRIA, VA, 22314, US

(21) Appl. No.: 11/111,852

(22) Filed: Apr. 22, 2005

(51) Int. Cl. G04C 3/00; G04B 37/00

(52) U.S. Cl. 368/276; 368/204

(57) ABSTRACT

A multifunctional desk-top inductive clock comprising: a display screen to output and display various data modes; a backlight board to output colors connecting with the display screen in order that the colors output from the backlight board directly projects onto the display screen; an induction controller connecting with the backlight board in order to simultaneously control the backlight board to change output colors and to render a display screen to change to display another data mode when the induction controller senses the ambient signals of the desk clock; and an electric power supplying module to supply electric power for the above stated elements.

### 1. FIELD OF THE INVENTION

The present invention is related to a multifunctional desk-top inductive clock, and especially to a multifunctional desk-top inductive clock having an induction controller that can simultaneously control a backlight board to change output colors, and to render a display screen to change to display another data mode when it senses the ambient signals of the desk clock.

### 2. DESCRIPTION OF THE PRIOR ART

People in modern time live in a society of high competition because of which time is very precious; for accurately handling every schedule of life and work, clocks and watches are necessary to tell time, however, taking the desk-top clocks such as alarm clocks and desk clocks often used for living houses as an example, their structure have been being very simple for a long, long time, they do not have additive function except more variant modeling and improved sounds for alarm clocks, and thereby their added value is low. While conventional desk-top electronic clocks may have more choices in function, they still need to have push buttons pressed with hands in order to get the information of some functions, and thereby is very inconvenient.

And more, time marks on conventional clocks can be seen clearly by users at day time and in an environment having bight lights, but evidently, once it is at a dark night or is in deficient in light beams, the time can not be displayed; although there are clocks having their figures, scales or indicating needles applied with fluorescent agent, in order that they can illuminate in the dark to make outstanding of the scales at that the indicating needles are; if it is in the circumstances with no light completely or with very weak light, they can not effectively show the time.

In view of these, for solving the above stated problems, the inventor developed the present invention based on his professional experience of years and nonstop studying, designing and improvement.

### SUMMARY OF THE INVENTION

The primary object of the present invention is to provide a multifunctional desk-top inductive clock having an induction controller that can simultaneously control a backlight board to change output colors, and to render a display screen to change to display another data mode when it senses the ambient signals of the desk clock.

To get the above objects of the present invention, the desk-top inductive clock of the present invention comprises: a display screen to output and display various data modes; a backlight board to output colors connecting with the display screen in order that the colors output from the backlight board can directly be projected onto the display screen; an induction controller connecting with the backlight board in order to simultaneously control the backlight board to change output colors and to render a display screen to change to display another data mode when the induction controller senses the ambient signals of the desk clock; and an electric power supplying module to supply electric power for the above stated elements.

The present invention will be apparent after reading the detailed description of the preferred embodiment thereof in reference to the accompanying drawings.

### BRIEF DESCRIPTION OF THE DRAWINGS

FIG. 1 is a perspective view of a preferred embodiment of the present invention;

FIG. 2 is a rear view of the preferred embodiment of the present invention;

FIG. 3 shows a partial sectional view of the preferred embodiment of the present invention;

FIG. 4 is a schematic view of the preferred embodiment of the present invention showing a date;

FIG. 5 is a schematic view of the preferred embodiment of the present invention showing a value of temperature;

FIG. 6 is a schematic view of the preferred embodiment of the present invention showing a state set up for the alarm clock;

FIG. 7 is a schematic view of the preferred embodiment of the present invention showing a state set up for counting time backwards.

### DETAILED DESCRIPTION OF THE PREFERRED EMBODIMENT

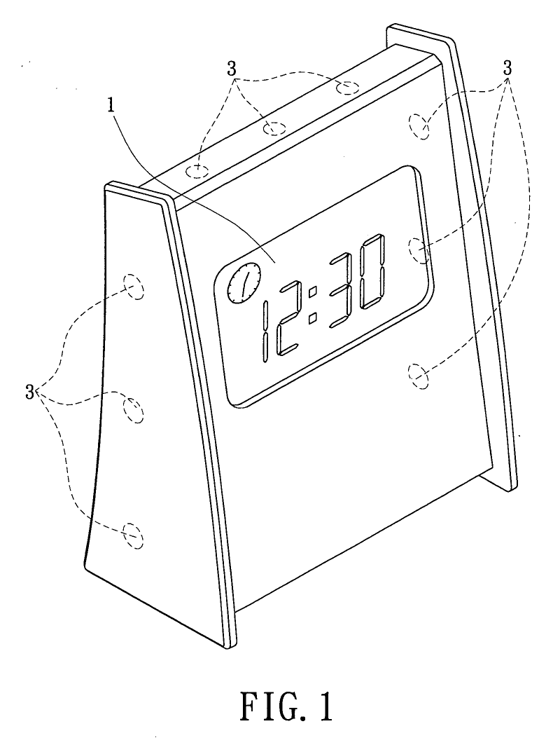

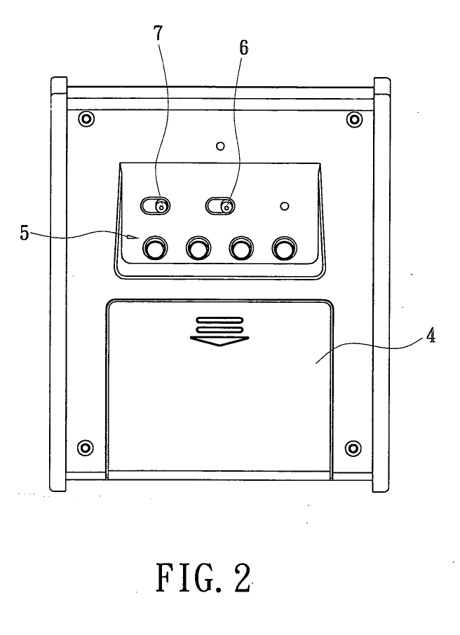

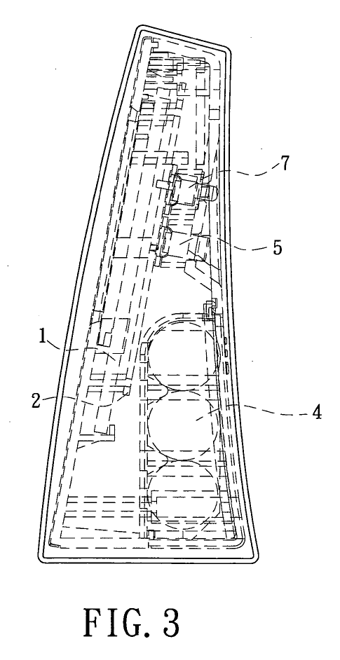

Referring to FIGS. 1-3 showing a preferred embodiment of a multifunctional desk-top inductive clock of the present invention, it comprises: a (or a plurality of) display screen 1, a backlight board 2 to output colors, an induction controller 3 and an electric power supplying module 4.

The display screen 1 is an LCD display screen provided to display various outputs such as time, date, temperature, setting of an alarm clock and counting time backwards in data modes;

The backlight board 2 is provided to output colors connecting with the display screen 1 in order that the colors output from the backlight board 2 can directly be projected onto the display screen 1; any color output from the backlight board 2 corresponds to one kind of data mode displayed on the display screen 1.

The induction controller 3 is provided on two lateral sides and the upper side of the multifunctional desk-top inductive clock, and is connecting with the backlight board 2 in order to simultaneously control the backlight board 2 to change output colors and to render a display screen 1 to change to display another data mode when the induction controller 3 senses the ambient signals of the desk clock. And the electric power supplying module 4 is provided to supply electric power for the above stated elements; it includes a direct current/alternating current power supplying module.

And more, the multifunctional desk-top inductive clock of the present invention is provided on its outer surfaces with a plurality of control keys 5 and switching keys 6, 7, wherein the control keys 5 are used to set up and adjust time, date, temperature and setting of the alarm clock, or to count time backwards in data mode, and these switching keys 6, 7 are used respectively to switch between turning on and off of the induction controller 3 and to switch for various control modes.

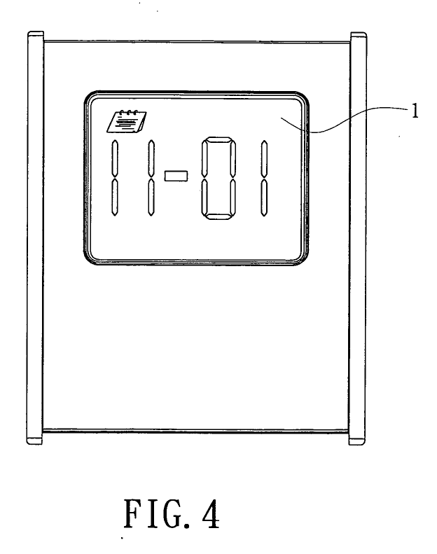

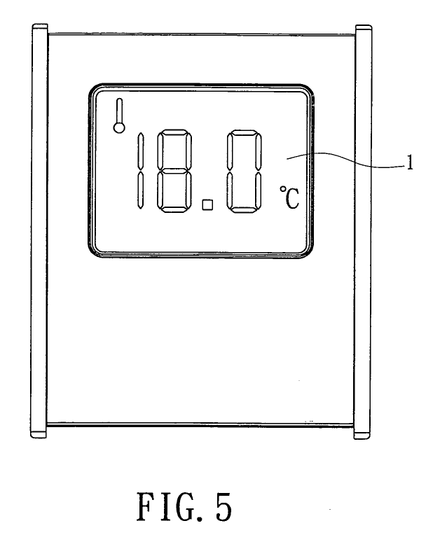

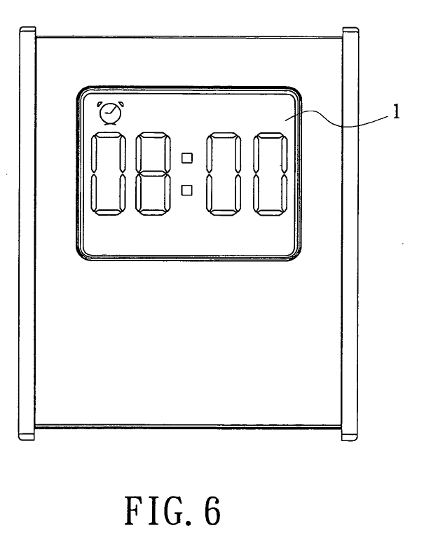

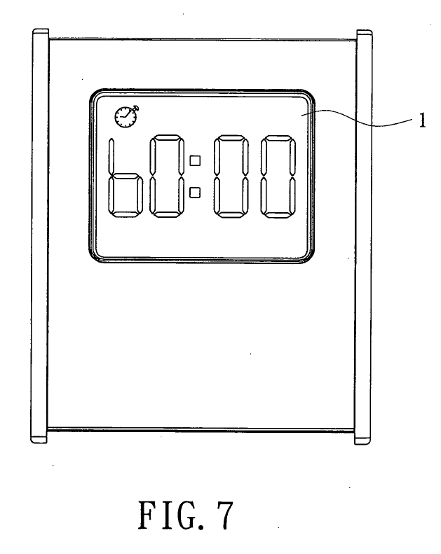

Therefore, when in practicing, when the switching key 6 of the induction controller 3 is switched to “off”, the display screen 1 displays a data mode (such as time, date, temperature, setting of an alarm clock or counting time backwards), the backlight board 2 does not act; when the switching key 6 of the induction controller 3 is switched to “on”, while the switching key 7 for switching between different control modes is switched to “off”, once the induction controller 3 senses a signal from outside of the desk clock (such as a user lightly touches the multifunctional desk-top inductive clock of the present invention or waves his hands around the clock), referring simultaneously to FIGS. 4-7, the display screen 1 changes to display another data mode (such as time, date, temperature, setting of an alarm clock or counting time backwards), and meantime the backlight board 2 changes the output colors; when the switching key 6 of the induction controller 3 is switched to “on”, and the switching key 7 is also switched to “on”, once the induction controller 3 senses a signal from outside of the desk clock, the backlight board 2 only outputs those colors (such as red, orange, blue, green or violet) in corresponding to the data mode displayed on the display screen 1, what are displayed on the display screen 1 still are of the originally set data mode (such as time, date, temperature, setting of an alarm clock or counting time backwards).

Thereby, when in an environment that is dark and deficient in light beams, the user needs only to lightly touch the multifunctional desk-top inductive clock of the present invention or wave his hands around the clock, the induction controller 3 senses a signal from the user to make setting up by means of the switching keys 6, 7, the output color of the backlight board 2 can thus be controlled can changed, and the display screen 1 can be repeatedly changed to another one of the data modes.

Therefore, the present invention has the following advantages:
1. The present invention is designed to have an induction controller and a backlight board in order to simultaneously control the backlight board to change output colors when it senses the ambient signals of the desk clock, so that a user needs only to lightly touch the multifunctional desk-top inductive clock of the present invention or waves his hands around the clock in an environment that is dark and deficient in light beams, the data mode on a display screen can be clearly displayed.
2. The display screen of the present invention can be repeatedly changed to another one of the data modes at any time by a signal received by the induction controller, so that the user needs not to do the actions of pressing and setting up one by one as is the case of conventional structures, and he can easily change the data mode on the display screen to obtain information.

In conclusion, according to the description disclosed above, the present invention surely can get the expected object thereof to provide a multifunctional desk-top inductive clock having high industrial value; and

What i claim as new and desire to be secured by Letters Patent of the United States is:

1. A multifunctional desk-top inductive clock comprising:
a display screen to output and display various data modes;
a backlight board to output colors and in connection with said display screen in order that said colors output from said backlight board directly projects onto said display screen;
an induction controller connecting with said backlight board in order to simultaneously control said backlight board to change output colors and to render said display screen to change to display another one of said data modes when said induction controller senses ambient signals of said desk-top inductive clock;
and an electric power supplying module to supply electric power for the above stated elements.

2. The multifunctional desk-top inductive clock as in claim 1, wherein said display screen is provided to display respective one of various outputs in data modes including time, date, temperature, setting of an alarm clock and counting time backwards.

3. The multifunctional desk-top inductive clock as in claim 1, wherein any color output from said backlight board corresponds to one of said data modes displayed on said display screen.

4. The multifunctional desk-top inductive clock as in claim 1, wherein said clock is provided with a plurality of control keys and switching keys, said control keys are used to set up and adjust said data modes including time, date, temperature and setting of the alarm clock, or to count time backwards, and said switching keys are used respectively to switch between turning on and off of said induction controller and to switch for various control modes.

5. The multifunctional desk-top inductive clock as in claim 4, wherein when one of said switching keys for switching between different control modes is switched to “off”, once said induction controller for mode controlling senses a signal from outside of said desk-top clock, said display screen changes to display another one of said data modes, and meantime said backlight board changes output colors; when said switching key for switching between different control modes is switched to “on”, once said induction controller senses a signal from outside of said desk clock, said backlight board only outputs those colors in corresponding to the one of said data modes displayed on said display screen.

6. The multifunctional desk-top inductive clock as in claim 1, wherein said induction controller is provided on two lateral sides and an upper side of said multifunctional desk-top inductive clock.

7. The multifunctional desk-top inductive clock as in claim 1, wherein said electric power supplying module is provided to supply electric power includes a direct current/alternating current power supplying module.
